(19) United States
(12) Patent Application Publication
(10) Pub. No.: US 2015/0107580 A1
(43) Pub. Date: Apr. 23, 2015

(54) BEARING ARRANGEMENT AND PARABOLIC TROUGH COLLECTOR

(71) Applicant: Schaeffler Technologies GmbH & Co. KG, Herzogenaurach (DE)

(72) Inventors: Martin Weber, Eckental (DE); Jorg Bauer, Erlangen (DE); Jurgen Donath, Dusseldorf (DE)

(73) Assignee: SCHAEFFLER TECHNOLOGIES GMBH & CO. KG, Herzogenaurach (DE)

(21) Appl. No.: 14/398,808

(22) PCT Filed: Apr. 2, 2013
(86) PCT No.: PCT/EP2013/056865

§ 371 Date: Nov. 4, 2014

(30) Foreign Application Priority Data
May 9, 2012 (DE) 102012207749.9

(51) Int. Cl. F24J 2/54; F16C 13/04; F16C 17/26; F16C 13/00

(52) U.S. Cl. CPC F24J 2/5403; F16C 13/006; F16C 13/04; F16C 17/26; F24J 2002/5482
USPC 126/600; 384/444

(57) ABSTRACT

The invention relates to a bearing arrangement (1), in particular for bearing the carrying shaft (30) of a parabolic trough collector (26), having a disc- or ring-shaped component (3), at least one support roller (5), which radially fixes the component (3) and on which the component (3) rolls on the circumferential side during rotation about a rotation axis (2), and a support structure (6), on which the support roller (5) is mounted by a radial sliding bearing (8). According to the invention, the lateral surface (12) of the support roller (5) which receives the component (3) has a convex curve in the axial direction. The invention further relates to parabolic trough collector (26) mounted on a plurality of such bearing arrangements (1).

### FIELD OF THE INVENTION

The invention relates to a bearing arrangement, in particular, for supporting the shaft of a parabolic trough collector, with a disk-shaped or ring-shaped component, with at least one support roller that fixes the component in the radial direction and on which the component rolls on the circumferential side when rotating about a rotational axis, and with a bearing construction on which the support roller is supported by means of a radial sliding bearing. The invention further relates to a parabolic trough collector with a number of collector elements that are arranged along a supporting shaft assembled from individual pipe sections, wherein the pipe sections are each joined by a flange disk, and wherein the shaft is supported with each flange disk as a component in a plurality of the previously mentioned bearing arrangements.

### BACKGROUND

A bearing arrangement of the type noted above is known, for example, from the published DE 10 2011 082 681.5. By combining a radial rolling bearing, wherein the component and the support roller are the rolling partners, with a radial sliding bearing, wherein the support roller and a bearing element of the supporting construction are the sliding partners, when adjusting an especially heavy component, the break-away torque required for the transition from static friction to dynamic friction and the torque required for rotation are reduced relative to a pure sliding bearing. The support roller here forms a transmission stage, wherein the required torques are reduced by a factor that corresponds to the ratio from the inner diameter to the outer diameter of the support roller.

For a parabolic trough collector, it is further known from the mentioned prior art to support the shaft (also called torsion bar) of the collector elements by means of several bearing arrangements of the previously described type and spaced apart from each other. The supporting shaft is here assembled from a plurality of individual pipe sections joined to each other. The total length of the supporting shaft can be over 100 m. For rotating the supporting shaft, the collector elements must be aligned over the entire structural length as exactly as possible to the current sun position, in order to achieve optimum focusing of the sunlight on an absorber. If the sliding friction or the break-away torque in the individual bearing arrangements is too large, this produces undesired twisting over the structural length of the supporting shaft and thus to only sub-optimal alignment of the collector elements, which degrades the efficiency of the parabolic trough collector.

According to the prior art, the flange disks connecting the individual pipe sections are each supported in the radial direction as a component in the bearing arrangement. By combining rolling bearings and sliding bearings it is possible to reduce the break-away torque and the torque required for rotational motion. In addition, an ultrasonic actuator is allocated to each bearing arrangement provided and this actuator causes the bearing surfaces to vibrate for further reducing the sliding friction and/or the break-away torque. For a parabolic trough power plant with a plurality of parabolic trough collectors that are supported on their part on a plurality of bearing arrangements, such additional ultrasonic actuators increase, on one hand, the costs of the entire system and, on the other hand, the operating costs overall due to the increased energy requirements.

### SUMMARY

The invention is based on the object of providing a bearing arrangement of the type noted above that is as economical as possible with the same ability and has the lowest possible operating costs during its operation. The invention is also based on the object of providing a parabolic trough collector that can be operated with the lowest possible costs.

The first objective is met according to the invention for a bearing arrangement of the type noted above in that the lateral surface of the support roller holding the component has a convex crowning in the axial direction.

The invention here starts, in a first step, from the knowledge that when two real bodies touch, the contact line or contact surface expected based on each of their shapes is not generated, but instead a different contact surface of a certain geometric shape is produced due to mechanical deformation. The shape of a real contact surface can be determined according to Hertzian contact theory. The greatest pressure resulting within the real contact surface is also called the Hertzian contact stress. Increased Hertzian contact stress leads to increased wear. This also increases the break-away torque and the sliding friction in the sliding bearing of the support roller.

In a second step, the invention starts from the idea that the Hertzian contact stress can be undesirably further increased by tilting two rolling partners relative to each other as a function of their profiles. For example, if cylindrical rolling partners are tilted relative to each other, this produces an increase in the Hertzian contact stress on one side. In particular, by supporting the supporting shaft of a parabolic trough collector by means of the flange disks connecting the individual pipe sections to each other, a tilting of the rolling partners to each other cannot be ruled out. In particular, the differences in length expected during fluctuating temperatures due to the large structural lengths can contribute to this effect.

Finally, in a third step, the invention recognizes that the Hertzian contact stress of the generated contact surface between the component and the support roller can be reduced such that the lateral surface of the support roller has a convex crowning in the axial direction. Here, the pressure load is homogenized. The expected maximum value of the Hertzian contact stress is also reduced relative to a cylindrical profile of the support roller. In addition, a convex construction of the lateral surface shows lower sensitivity of the Hertzian contact stress to tilting of the rolling partners.

The invention makes it possible, especially for the support of heavy components, to further reduce the break-away torque and the friction in the bearing arrangement. Tests have shown that, especially for the support of the supporting shaft of a parabolic trough collector with a convex lateral surface of the support roller, an ultrasonic actuator for generating vibrations that reduce the break-away torque and the friction can be eliminated.

In a preferred construction, the component is supported by two support rollers spaced apart from each other perpendicular to the rotational axis. For this construction, the component is set, in particular, on two side support rollers that distribute the weight. Here, the component dips between these two support rollers to different depths as a function of the distance of the support rollers. The lateral stability of the bearing arrangement can be designed according to requirements by means of selecting the distance between the support rollers.

In another preferred construction, the lateral surface of the support roller or each support roller is limited in the axial direction on the two end sides by a circumferential collar. Here, reference is made, in particular, to the fact that the bearing arrangement must receive an axial offset of the supported component as it occurs in the support of the supporting shaft of a parabolic trough collector. For example, if the bearing shaft is fixed in the axial direction on the drive position, this can produce temperature-dependent differences in length of up to a few 10s of centimeters at the other end of the bearing shaft. By the use of the collar applied on both ends of the support roller, an axial motion of the component (that is, e.g., a flange disk of a parabolic trough collector) is received by the support roller, so that this slides relative to the bearing element not only with a rotational motion but also in the axial direction with a translational motion. Through this construction, the rolling bearing can be optimized between the support roller and component and also the sliding bearing between the support roller and bearing element or supporting construction independently of each other with regard to the running or sliding surfaces.

Each collar on the ends of the support roller is preferably inclined away in the radial direction outward from the lateral surface. In other words, the distance between the two collars becomes larger outward in the radial direction. In this way, the inner side of a collar forming the axial stop for the component can be optimized with regard to friction, because the size of the contact surface between component and collar can be reduced through a suitable construction.

Preferably the support roller is made from a metal that is hardened at least in the area of the outer lateral surface and on which a chemically bonded protective layer is applied. The outer lateral surface of the support roller forms the running surface along which the supported component rolls with its outer circumference. By hardening this area, optionally including the inner side of the collars arranged on the ends, the running properties can be improved. In particular, by hardening and by a chemically bonded anti-corrosion and/or anti-wear layer, the rolling friction and the wear resistance can be increased. A layer made from nickel or zinc-nickel has proven especially advantageous as such a protective layer.

Preferably the radial sliding bearing of the support roller is formed on the supporting construction such that the support roller is supported on a pin mounted on the supporting construction so that it can rotate and move in the axial direction. Here, the inner circumference of the support roller and the surface of the pin can be covered with suitable sliding layers that reduce the wear and the dynamic friction relative to each other.

In another advantageous construction, a sliding bushing mounted on the support roller is inserted between the support roller and pin. The sliding bushing itself is made from a suitable sliding material in a first alternative. In an alternative construction, the sliding bushing is made, for example, from a metal, wherein a suitable sliding material is applied on the inner jacket of the sliding bushing. The sliding bushing can be inserted into a central hole of the support roller by means of an interference fit. The sliding bushing, however, can also be bonded, welded, or joined there in some other way.

Preferably, at least the outer circumferential area of the component is made from a hardened metal on which a galvanically deposited protective layer is applied. Here reference is also made to the running properties that the component should have relative to the support roller. In an especially preferred construction, the component is made from steel that is hardened at least on the top side, wherein a chromium layer is deposited galvanically on the surface as an anti-corrosion and/or anti-wear layer.

In a further preferred way, the outer circumferential area of the component has a tire-like cross-sectional profile with an essentially flat, radial contact surface and two axial side surface curved outward. Through this construction, in conjunction with the convex lateral surface of the support roller, a uniform and low Hertzian contact stress is produced. The curved axial side surfaces optimize the contact surface relative to the inner sides of the collar acting as axial stops with regard to friction and wear.

For a parabolic trough collector with a number of collector elements that are arranged along a supporting shaft assembled from individual pipe sections, wherein the pipe sections are each joined by means of a flange disk, the second problem is solved according to the invention in that the supporting shaft is supported with each flange disk as a component in a plurality of bearing arrangements of the previously described type. In particular, at least one of the flange disks is held fixed in the axial direction for driving a rotational motion.

The advantages noted for advantageous constructions of the bearing arrangement can be transferred here analogously to the parabolic trough collector.

The drive of the bearing shaft is preferably constructed with an axial fixed bearing. A somewhat axial offset of the bearing shaft due to temperature fluctuations is received by means of each bearing arrangement. Through the breakaway torque reduced due to the crowning of the lateral surface of the support roller and the similarly reduced dynamic friction of the bearing arrangement it is guaranteed that for a one-side drive of the supporting shaft, this is moved over its entire structural length into the desired rotational position, so that the collector elements can be tracked ideally to the path of the sun for focusing the sunlight onto the absorber. The use of expensive additional ultrasonic actuators that set the sliding surfaces of the bearing arrangement into vibrations can be eliminated.

### BRIEF DESCRIPTION OF THE DRAWINGS

Embodiments of the invention will be explained in more detail with reference to the drawings. Shown are:

FIG. 1 in a three-dimensional view, a bearing arrangement with a component that is supported between two support rollers,

FIG. 2 in a sectional view, the contact area of the component in the support roller,

FIG. 3 in a partially set-off representation, the sliding area of the support roller on a pin, and

FIG. 4 schematically, a partial area of a parabolic trough collector with a bearing arrangement corresponding to FIG. 1.

### DETAILED DESCRIPTION OF THE PREFERRED EMBODIMENTS

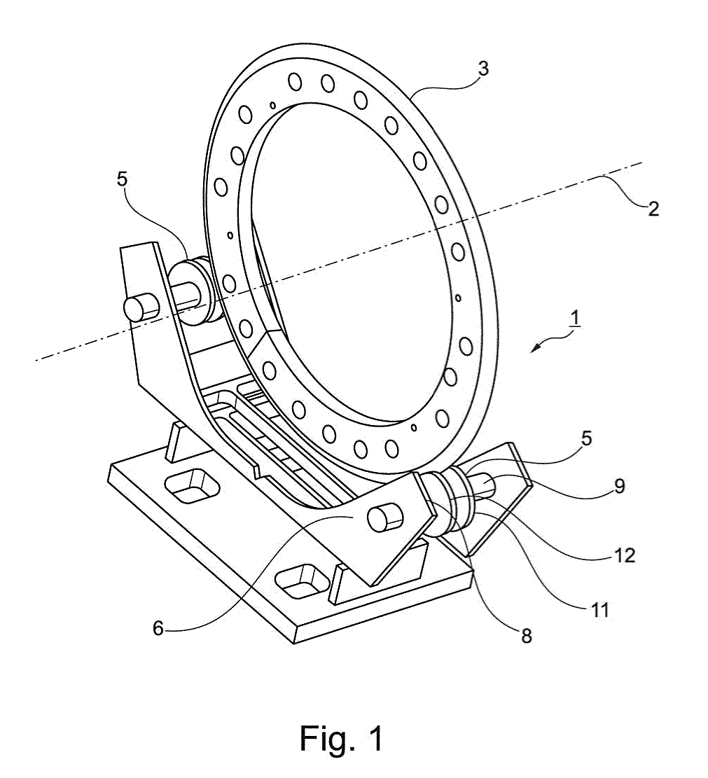

FIG. 1 shows, in a three-dimensional view, a bearing arrangement 1 for the support of a ring-shaped component 3 so that it can rotate about the rotational axis 2. The component 3 is here held between two side support rollers 5 that are supported, on their side, on a supporting construction 6.

The support rollers 5 fix the component 3 in the radial direction. When rotating about the rotational axis 2, the component 3 rolls on the support rollers 5 on the circumferential side. Each of the support rollers 5 is supported by means of a radial sliding bearing 8 on the supporting construction 6. The radial sliding bearing 8 is here formed by a sliding support of the support roller 5 on a pin 9 that is joined rigidly to the supporting construction 6. Each of the support rollers 5 further comprises a collar 11 on the two end sides. Between the collars 11, the component 3 dips with its circumferential line up to the lateral surface 12 of the support roller 5.

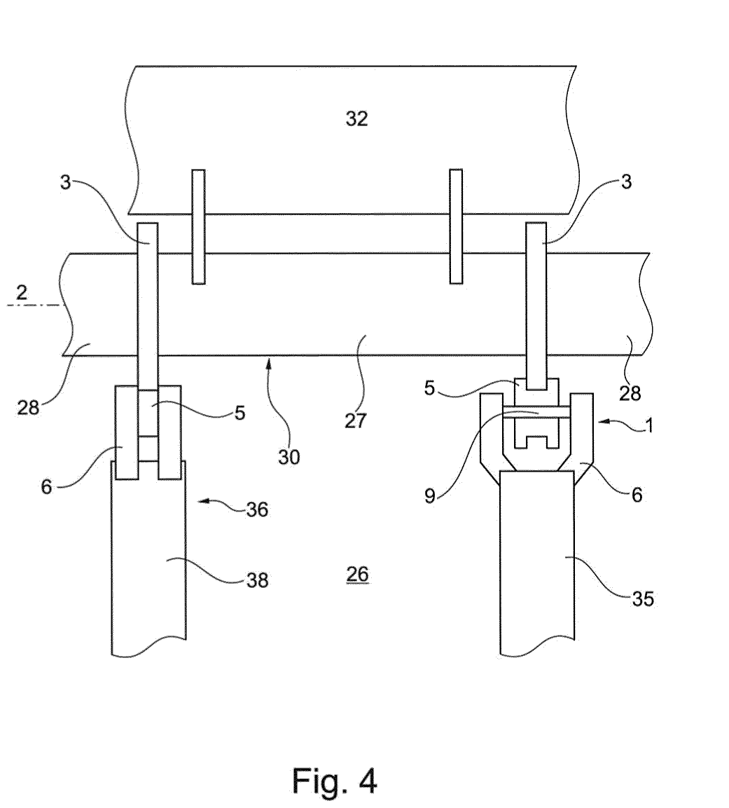

The illustrated component 3 corresponds to a flange disk, as it connects two pipe sections 27, 28 of a supporting shaft 30 of a parabolic trough collector 26 corresponding to FIG. 4.

Through the combination of a roller bearing between component 3 and support roller 5 with a sliding bearing between support roller 5 and pin 9 or supporting construction 6, compared with a pure radial sliding bearing, wherein the circumference of the component 3 rotates with sliding on a sliding block, the break-away torque when transitioning between static friction and dynamic friction is reduced. The dynamic friction as such is also reduced. The cause for these results is the support roller 5 that represents a transmission stage via its inner and outer circumferences.

Due to the reduced break-away torque and the reduced dynamic friction, the bearing arrangement 1 according to FIG. 1 is suitable, in particular, for supporting heavy, rotating loads, wherein an exact rotational positioning is required. Especially for supporting the supporting shaft of a parabolic trough collector, it is guaranteed through such bearing arrangements 1 that for a one-sided drive of the supporting shaft, there is no rotation along the structural length, so that an exact alignment of the collector elements is possible.

So that the support roller 5 is guided sliding on the pin 9, in the axial direction, a translating offset of the support roller 5 is possible, wherein the component 3 also remains fixed in the radial direction. The bearing arrangement 1 is therefore able to take over an axial offset of the component 3, without the bearing properties being changed as such. Just the supporting shaft of a parabolic trough collector results in the mentioned large changes in length due to temperature fluctuations, where these changes can be compensated by the shown bearing arrangement 1. With an axial offset of the component 3 (in particular, the flange disk of a supporting shaft of a parabolic trough collector), the collars 11 form an axial contact surface for an edge area of the component 3. When there is contact with the component 3, each support roller 5 is shifted along the pin 9.

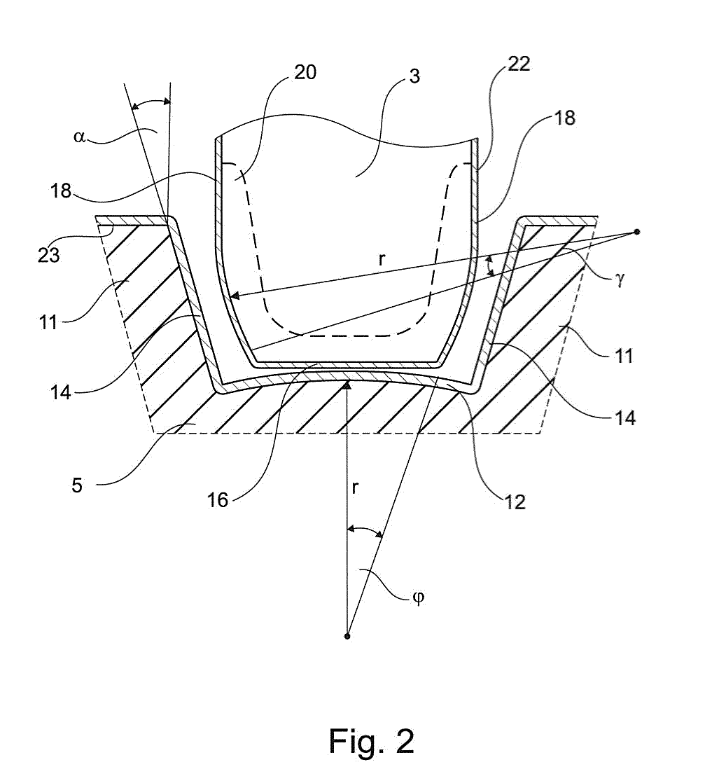

In FIG. 2, in a sectional view, the supporting area of the circumference of component 3 on the lateral surface 12 of a support roller 5 is shown. It can be seen how the edge area on the circumferential edge area of the component 3 here sips into the space between the collars 11. The inner surfaces 14 of the collar 11 form axial contact surfaces for the component 3.

The lateral surface 12 is constructed with a convex crowning in the axial direction. Here, a radius r describing an axial contour line of the lateral surface 12 can be constant or else vary over the angle φ. The function of the length of the radius r over the angle φ uniquely defines the axial contour line of the lateral surface 12.

By use of the convex crowning of the lateral surface 12 it is achieved that the Hertzian contact stress on the contact surface between the contact surface 16 of the component 3 and the lateral surface 12 of the support roller 5 is comparatively low and also has a homogeneous curve. Tilting the component 3 relative to the support roller 5 does not significantly increase the Hertzian contact stress. The contact surface 16 of the component 3 is here selected to be essentially flat.

The inner surfaces 14 of the collar 11 forming each axial stop are inclined outward away from the lateral surface 12. In other words, the distance between the surfaces 14 of the collar 11 is greater outward in the radial direction. The inclination of the surfaces 14 relative to the radial direction is designated with the angle α.

The circumferential area of the component 3 overall has a tire-like cross section. The radial contact surface 16 is essentially flat. The two side surfaces 18 are curved outward. Each radial contour line along a side surface 18 of the component 3 is described over the profile of the length of a radius r over the angle _{Υ}.

The component 3 is constructed as a flange disk of a parabolic trough collector and is made from a steel material. In a surface area 20, the steel is hardened. The outer side of the component 3 is provided, in the area of its circumference, with a galvanically applied protective layer 18 made from chromium. The support roller 5 is made overall from a hardened steel. A chemically bonded protective layer 23 made from nickel is applied on the surface of the support roller 5.

The rolling partners, component 3 and support roller 5, are constructed overall, both in their geometric construction and also in their surface conditions, for low rolling friction and for high wear resistance. Through the inclined collar 11 and the convex side surface 18, low friction and high wear resistance is also achieved in the area of the axial stop.

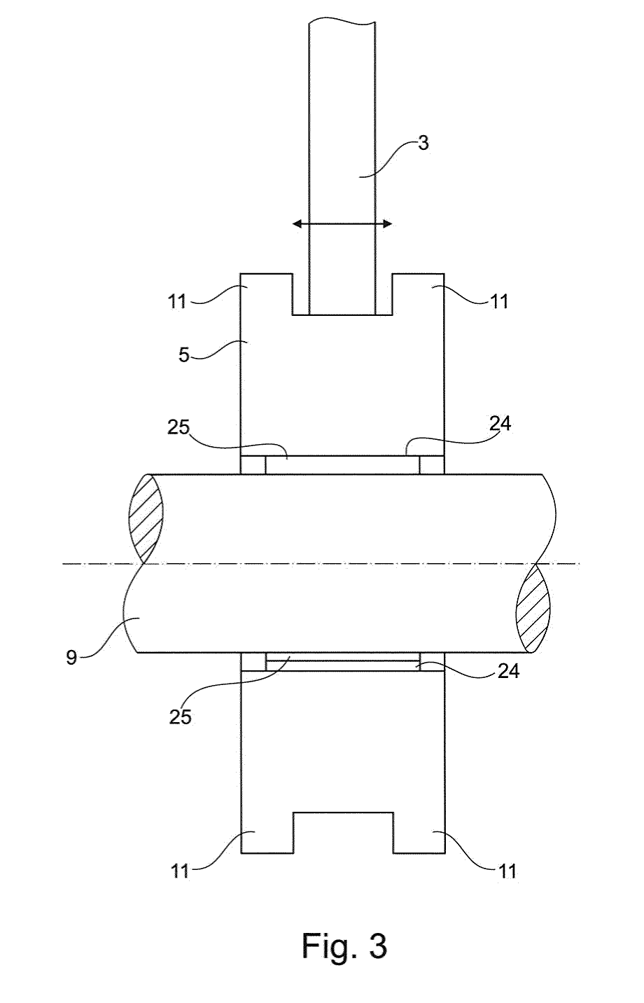

In FIG. 3, in a half set-off representation, the sliding area of the support roller 5 is shown on the pin 9. The two collars 11 can be seen of each sectioned support roller 5, with the component 3 dipping with its circumferential side between these collars. A possible axial offset of the component 3 is characterized by arrows. A sliding bushing 24 is pressed into a central hole of the support roller 5 to optimize the friction between the support roller 5 and the pin 9.

For the sliding bushing 24, two alternatives are shown. In the alternative shown at the top in FIG. 3, the sliding bushing 24 is made overall from a sliding material 25. According to the alternative shown at the bottom in FIG. 3, the sliding bushing 24 is made from a steel, with a sliding material 25 being deposited as a layer on the inner circumference.

For the component 3, the support roller 5 and the pin 9 form a radial sliding bearing. In addition to a rotational motion, a translating motion of the support roller 5 along the pin 9 is also possible by means of these same sliding partners.

In FIG. 4, the construction of a parabolic trough collector 26 is shown schematically. Here, the parabolic trough collector 26 comprises a supporting shaft 30 that can rotate about a rotational axis 2 and is assembled from individual pipe sections 27, 28. On the supporting shaft 30, collector elements 32 are mounted along the entire structural length. By rotating the supporting shaft 30, the collector elements 32 are pivoted uniformly overall, so that incident sunlight can be focused onto an absorber.

The individual pipe sections 27, 28 of the supporting shaft 30 are connected to each other by means of a flange disk (designated above as component 3). Each of the flange disks 3 is supported in the radial direction with an axial degree of freedom by means of a bearing arrangement 1 corresponding to FIG. 1 on a pylon 35. In this way, changes in length of the supporting shaft 30 are absorbed.

At one point of the supporting shaft 30, this shaft is held on an axial fixed bearing 36. The axial degree of freedom of a support roller 5 is here limited by the correspondingly constructed supporting construction 6. The axial fixed bearing 36 is supported by a drive pylon 38. A hydraulic drive that is not shown in more detail is mounted on this pylon 38, by means of which the supporting shaft 30 can be rotated by a specified angle in a controlled way.

### LIST OF REFERENCE NUMBERS

1 Bearing arrangement
2 Rotational axis
3 Component
5 Support roll
6 Supporting construction
8 Radial sliding bearing
9 Pin
11 Collar
12 Lateral surface
14 Surfaces
16 Contact surface
18 Side surface
20 Hardening area
22 Galvanic chrome layer
23 Bonded nickel layer
24 Sliding bushing
25 Sliding material
26 Parabolic trough collector
27 Pipe section
28 Pipe section
30 Supporting shaft
32 Collector element
35 Pylon
36 Fixed bearing
38 Drive pylon

1. A bearing arrangement for supporting a supporting shaft of a parabolic trough collector, comprising a disk-shaped or ring-shaped component, with at least one support roller that fixes the disk-shaped or ring-shaped component in a radial direction and on which the disk-shaped or ring-shaped component rolls on a circumferential side when rotating about a rotational axis, and a supporting construction on which the support roller is mounted by a radial sliding bearing, a lateral surface of the support roller holding the disk-shaped or ring-shaped component has a convex crowning in an axial direction.

2. The bearing arrangement according to claim 1, wherein the disk-shaped or ring-shaped component is supported by two of the support rollers spaced apart from each other perpendicular to the rotational axis.

3. The bearing arrangement according to claim 1, wherein the lateral surface of the support roller is limited on two end sides in the axial direction by a circumferential collar.

4. The bearing arrangement according to claim 3, wherein an inner surface of each of the collars in the axial direction is inclined away from the lateral surface outward in the radial direction.

5. The bearing arrangement according to claim 1, wherein the support roller is made from a hardened metal at least in an area of the lateral surface, with a chemically bonded protective layer being applied on said metal.

6. The bearing arrangement according to claim 1, wherein the support roller is supported on a pin mounted on the supporting construction so that it can rotate and move in the axial direction.

7. The bearing arrangement according to claim 6, wherein a sliding bushing mounted on the support roller is inserted between the support roller and the pin.

8. The bearing arrangement according to claim 1, wherein at least an outer circumferential area of the disk-shaped or ring-shaped component is made from a hardened metal, with a galvanically deposited protective layer being applied on said metal.

9. The bearing arrangement according to claim 1, wherein an outer circumferential area of the disk-shaped or ring-shaped component has a tire-shaped cross-sectional profile with an essentially flat radial contact surface and with two axial side surfaces each bulging outward.

10. A parabolic trough collector comprising a number of collector elements that are arranged along a supporting shaft assembled from individual pipe sections, wherein the pipe sections are each joined by a flange disk, a supporting shaft is supported with the corresponding flange disk as the disk-shaped or ring-shaped component in a plurality of bearing arrangements according to claim 1.
